(19) United States
(12) Patent Application Publication
(10) Pub. No.: US 2013/0143104 A1
(43) Pub. Date: Jun. 6, 2013

(54) BUTTON CELL COMPRISING A COATED EXTERIOR

(71) Applicants: Herbert Schein, Munningen (DE); Bernd Kreidler, Ellwangen (DE); Eduard Pytlik, Ellwangen (DE); Martin Krebs, Ellwangen (DE); Dejan llic, Ellwangen (DE)

(72) Inventors: Herbert Schein, Munningen (DE); Bernd Kreidler, Ellwangen (DE); Eduard Pytlik, Ellwangen (DE); Martin Krebs, Ellwangen (DE); Dejan llic, Ellwangen (DE)

(73) Assignee: VARTA MICROBATTERY GMBH, Hannover (DE)

(21) Appl. No.: 12/595,126

(22) PCT Filed: Apr. 8, 2008
(86) PCT No.: PCT/EP08/02764

§ 371 Date: Apr. 6, 2010

(30) Foreign Application Priority Data
Apr. 13, 2007 (DE) 10 2007 018 259.9

(51) Int. Cl. H01M 2/02

(52) U.S. Cl. CPC H01M 2/0207
USPC 429/162; 29/623.5

(57) ABSTRACT

A button cell includes a housing including a cell cup and having an exterior electrically non-conductive coating, a cell cover and a seal which isolates the cell cup and the cell cover from one another.

### RELATED APPLICATIONS

This is a §371 of International Application No. PCT/EP2008/002764, with an international filing date of Apr. 8,2008 (WO 2008/125246 A2, published Oct. 23, 2008), which is based on German Patent Application No. 10 2007 018 259.9, filed Apr. 13, 2007.

### TECHNICAL FIELD

This disclosure relates to a button cell having a housing comprising a cell cup, a cell cover and a seal which isolates the cell cup and the cell cover from one another, to a method which is suitable for production of such a button cell, and to a novel use of electrically non-conductive coating materials for button cells.

### BACKGROUND

In general, button cells have a cell cup and a cell cover. By way of example, the cell cup may be produced from nickel-plated deep-drawn sheet metal. The cell cup normally has positive polarity, and the cell cover negative polarity. Button cells such as these may contain widely differing electrochemical systems, for example, nickel/cadmium, nickel/metal hydride, zinc/air (MnO2) or else primary and secondary lithium systems.

Cells such as these are generally closed in a liquid-tight manner by peening the edge of the cell cup over the cell cover. A plastic ring which is arranged between the cell cup and the cell cover is in this case normally used as a seal, and isolates the cell cup from the cell cover. Button cells such as these are known, for example, from DE 31 13 309.

The nickel-plated deep-drawn sheet metal mentioned above is frequently the housing metal of choice, since it is cheap and nickel offers good corrosion protection. Furthermore, nickel does not form a thick oxide layer on its surface in normal conditions. Correspondingly, nickel-plating generally ensures permanently good electrical contact with the electrical contact units of a load.

Cell cups and cell covers composed of nickel-plated deep-drawn sheet metal are preferably produced by electrochemical application of a nickel layer onto correspondingly shaped metal parts. Alternatively, cell cups and cell covers can also be produced directly as stamped and drawn parts composed of nickel-plated deep-drawn sheet metal. In both cases, the nickel layer normally has a certain amount of porosity. This normally does not represent any problem, but, in extreme conditions (for example, at high temperatures and in high air humidity, for example, as occur in tropical areas), this can lead to rust blooming adjacent to the pores, which can lead to contamination of the load and to the button cell becoming unusable.

This problem also occurs in a particularly pronounced and frequent form in the case of button cells which are used in hearing aids. Unavoidable bodily vapors in the ear together with human body heat ensure a highly aggressive climate, as a result of which the hearing aid and button cell are equally subject to pronounced corrosion attacks.

With regard to corrosion attacks on button cells, the area of the flange, in particular, is highly critical because the distance between the cell parts of negative and positive polarity is very short in this area, and nickel protective layers close to the flange may be damaged or locally torn off.

It could therefore be helpful to provide a button cell which can be used safely and reliably in hearing aids without contaminating them or even making them unusable.

### SUMMARY

We provide a button cell including a housing including a cell cup and having an exterior electrically non-conductive coating, a cell cover and a seal which isolates the cell cup and the cell cover from one another.

We also provide a method for producing a corrosion-protected button cell including applying at least one electrically non-conductive coating material to at least a portion of an exterior portion of the button cell housing.

### BRIEF DESCRIPTION OF THE DRAWING

Advantages of the button cells and methods will become evident from the description of the examples which now follow, and from the drawing. The individual features can be implemented in their own right or in combination with one another. The described examples are intended only for explanatory purposes and to assist understanding, and should in no way be considered restrictive.

FIG. 1 is a schematic perspective view of one example of a button cell, partially broken away for ease of understanding.

### DETAILED DESCRIPTION

Our button cells have a housing which comprises a cell cup, a cell cover and a seal. The seal isolates the cell cup from the cell cover. On its exterior, the housing of a button cell has an electrically conductive (or conducting) coating which comprises at least one metal which is nobler than nickel, and/or at least one conductive compound. The electrically conductive coating may be composed of the at least one metal which is nobler than nickel and/or of the at least one conductive compound.

The at least one metal is preferably selected from the group comprising ruthenium, copper, silver, gold, rhodium, palladium, rhenium, osmium, iridium and platinum. This is preferably above nickel in the electrochemical potential series, that is to say it has a more positive normal potential.

The at least one conductive compound is, in particular, a metal or transition-metal compound. The at least one conductive compound is preferably a chalcogenide (for example indium tin oxide), a nitride (for example titanium nitride) or a carbide. Of the chalcogenides, oxides, sulfides and selenides are particularly preferred.

As an alternative or in addition to the electrically conductive coating, the button cells may have an electrically non-conductive coating on the exterior of the housing. Both the electrically conductive coating and the electrically non-conductive coating can effectively protect the button cell against corrosive attacks.

The electrically non-conductive coating is preferably at least partially composed of at least one organic component, in particular, of at least one organic component on a polymer basis.

The electrically non-conductive coating is particularly preferably a lacquer. Lacquers based on alkyd, epoxy and acrylate resin are particularly highly suitable. Nitride lacquers, polyester lacquers and polyurethane lacquers are likewise preferred.

The electrically non-conductive coating can, furthermore, also be a sheet, preferably a very thin sheet. Sheets with a thickness of between 0.01 mm and 0.3 mm are preferred. The sheet is preferably a thermoplastic sheet, in particular, a shrink sheet. The sheet is preferably composed of a polyolefin or of a polyamide. An adhesive layer may be located between the sheet and the exterior of the housing.

It may also be preferable for the electrically non-conductive coating to comprise at least one inorganic component, in particular, on the basis of glass and/or ceramic, and/or a non-conductive metal or transition-metal compound.

The electrically non-conductive coating may comprise an organic/inorganic hybrid component, in particular, based on Ormocer(r), or may be composed of this.

Ormocer® is an inorganic/organic hybrid polymer, which is suitable for influencing the surface characteristics of substrates composed of polymers, ceramic, glass, metal, paper and wood. In addition to increasing the mechanical and chemical resistance of the substrates, various additional functions can be produced on the surface. Inter alia, Ormocer® is very highly suitable for use as a barrier layer for gases, solvents and ions. Hydrophobic characteristics can also deliberately be achieved.

In general, Ormocer® is produced using the sol-gel method. First, an inorganic network is formed by controlled hydrolysis and condensation of organically modified silicon alkoxides. Co-condensation with other metal alkoxides (for example, Ti, Zr and Al alkoxides) is likewise possible. In a subsequent step, the polymerizable groups fixed on the inorganic network are crosslinked with one another inter alia thermally and/or by UV initiation. In addition, organically modified silicon alkoxides can be used which do not take part in organic polymerization reactions and therefore contribute to an organic functionalization of the inorganic network. An inorganic/organic copolymer is formed by this two-stage method. This can be applied to a substrate by means of a conventional coating method (dip or spraying method, wiping application, spin-on method, rolling application or micro-spray application), where it is cured in a subsequent step.

The electrically non-conductive coating may comprise an organic/inorganic hybrid component, in particular, based on a silicone compound, or may be composed of this. Silicones are heat-resistant and hydrophobic and therefore, are particularly highly suitable for use as a coating. The silicone compound is particularly preferably a silicone resin. The silicone compound may be a fluorosilicone. In the case of fluorosilicones, the methyl groups are replaced by fluoroalkyl groups. These have particularly high oxidation and chemical resistance.

Furthermore, it may be preferable for the electrically non-conductive coating to comprise or be composed of parylene. As is known, parylene is an inert, hydrophobic, optically transparent, polymeric coating material with a wide range of industrial applications. Parylene is produced by chemical gas-phase deposition. The raw material is di-para-xylylene or a halogenated derivative thereof. This is vaporized and passed through a high-temperature zone. In the process, a highly reactive monomer is formed which generally reacts immediately on the surface of the substrate to be coated, to form a polymer chain. All that is necessary in this case for curing is to keep the substrate to be coated at a temperature that is not too high, for example, at room temperature. Parylene is preferably applied in a vacuum by condensation from the gas phase as a pore-free and transparent polymer film to a substrate. Coating thicknesses from 0.1 μm to 50 μm can be applied in one process.

Furthermore, it may be preferable for the electrically non-conductive coating to comprise or be composed of a valve metal oxide. As is known, valve metals are metals or alloys whose oxides have dielectric characteristics. Examples are Al, Ti, Nb and Ta oxides. Valve metal oxide layers can in principle be used as rectifiers, that is to say they allow current to flow in only one direction and have a high insulating behavior in the other direction, even with very small layer thicknesses of less than 100 nm. This characteristic justifies the expression “valve metal.” At the same time, valve metal oxide layers are virtually transparent up to a specific thickness, as a result of which they can act as top layers on a glossy, highly reflective background as interference layers.

Suitable methods for production of valve metal coatings are available in thin-film technology, in particular, PVD technology. Within PVD technology, the so-called magnetron sputtering is particularly predestined for layer production. The surface roughness, with optimum coating parameters, is not negatively influenced by the method, and the layer porosity is sufficiently low for subsequent anodic oxidation.

The dominant method for production of valve metal oxide layers is anodic oxidation of valve metal coatings. The layer thickness can be controlled by the anodizing voltage in a preferred manner, provided that the valve metal layer is closed and the electrolyte composition as well as electrical and thermal parameters are selected optimally for the anodization. The coloring of bulk materials composed of valve metals, for example titanium rods or wires, is known.

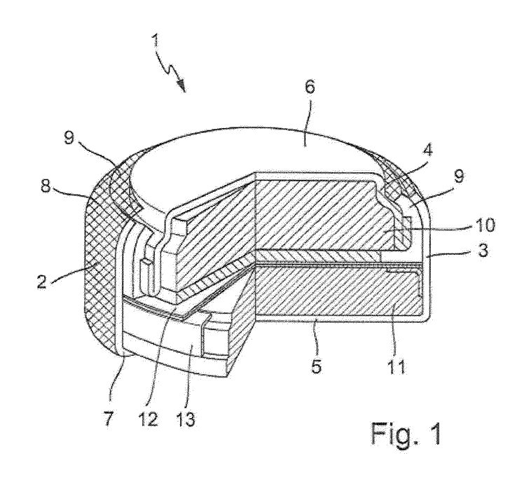

The housing of a button cell is preferably essentially cylindrical. Cell cups and cell covers of a button cell preferably have an essentially flat bottom area. These preferably form the upper face and the lower face of the button cell. The electrical contact units of a load are preferably fitted in these areas. The housing of the button cell preferably has a casing-like section which, in particular, is formed between the essentially flat bottom areas. This is preferably formed by the outer wall of the cell cup. The transition from the casing-like section to the flat bottom areas may, in particular, be in the form of an edge and/or may be rounded. This can be seen in the illustration in FIG. 1. The transition is preferably rounded toward the essentially flat bottom of the cell cover. There may be a flanged zone in which the rim of the cell cup is bent around and rests closely on the cell cover, preferably being separated from it only by the seal. In this area, there is a gap between the cell cup and the cell cover, which gap is generally only very thin, and in which the seal is arranged.

The button cell may have a diameter of <25 mm, in particular, of <15 mm. The height of the button cell is preferably less than 15 mm and, in particular, less than 10 mm.

The exterior of the housing may have one or more uncoated subareas. In these sub-areas, the housing is free of the electrically conductive and/pr of the electrically non-conductive coating.

In particular, it may be preferable for the button cell to have a cell cover with an essentially flat bottom and/or a cell cover with an essentially flat bottom, with the essentially flat area of the cover bottom and/or of the cup bottom being uncoated at least in places. This is particularly preferable with regard to the electrically non-conductive coating, since this would oppose an electrical contact made in the area of the cover bottom and/or the cup bottom.

It is, of course, also possible for the exterior of a button cell to have an electrically conductive coating and an electrically non-conductive coating at the same time, in which case the electrically conductive coating may essentially completely cover the exterior, while the electrically non-conductive coating is preferably applied only in subareas, as already mentioned, specifically, in particular, not in the area of the cover bottom and/or the cup bottom. However, the electrically conductive coating cannot produce an electrical contact between the cell cup and the cell cover, which are of opposite polarity.

The button cell may have a casing-like housing section which is provided at least in places with the electrically conductive coating and/or with the electrically non-conductive coating (2). In particular, the coating there is applied in the form of at least one circumferential strip.

The button cell may have a flanged area which is covered by the electrically non-conductive coating. The electrically non-conductive coating preferably covers the area of the cup rim completely. In particular, it may be preferable for the coating to cover the gap mentioned above between the cell cover and the cell cup in this area, possibly partially filling it.

As already mentioned initially, any nickel layer which may be present can be torn off during the peening process. The tom-off area then provides a particularly good surface for corrosive media to attack. This can be avoided or counteracted by application of the electrically non-conductive coating in this area. Furthermore, an electrically non-conductive coating which is applied in the flanged area may also have a sealing effect.

It is preferable for both the electrically conductive coating and the electrically non-conductive coating to be essentially impermeable to moisture, in particular, to air humidity. In particular, it is preferable for the coatings to be essentially pore-free, as a result of which, in particular, corrosively acting substances cannot penetrate through the coating.

Some coatings which are suitable can be deposited particularly well electro-chemically, or from the gas phase. For example, and in particular, the electrically conductive coating is preferably an electrochemical coating or a PVD coating (PVD=physical vapor deposition). A PVD coating is, as is known, a normally very thin coating which is applied using a vacuum-based coating method.

In general, the layer is formed directly by condensation of a vapor of the raw material. In principle, virtually all metals as well as carbon can be deposited in a highly pure form using a PVD method. If reactive gases such as oxygen, nitrogen or hydrocarbons are supplied to the process, oxides, nitrides or carbides can also be deposited. PVD coatings are frequently distinguished by their high level of hardness and scratch resistance.

Furthermore, it may be preferable for the electrically conductive coating or the electrically non-conductive coating to be a CVD coating (CVD=chemical vapor deposition). Both procedures have already been mentioned in conjunction with coatings composed of parylene and valve metal oxides. In addition, and in particular, coatings can also be deposited composed of a transition-metal compound, preferably of a transition-metal nitride, in particular, titanium nitride, using a PVD method. Inter alia, layers with ceramic components, for example, aluminum oxide, can also be deposited using a CVD method.

Both CVD coatings and PVD coatings may also be multilayer coatings.

The thickness of the electrically conductive coating is preferably between 50 nm and 20 μm, in particular, between 100 nm and 10 μm.

The electrically non-conductive coating preferably has a thickness of between 1 μm and 200 μm, in particular, between 1 μm and 100 μm, and particularly preferably between 5 um and 15 μm.

The button cell may have an electrically conductive coating and/or an electrically non-conductive coating, which contains at least one dye and/or at least one pigment.

In particular, it may be preferable for a button cell to be provided, in particular, in the casing area with a lacquer, in particular, a clear lacquer, which contains at least one color pigment.

The cell cover and/or the cell cup of a button cell is or are preferably composed of at least one metal and/or at least one metal alloy. Suitable metallic materials are known. For example, the initially already mentioned cell cover and cell cup composed of nickel-plated deep-drawn sheet metal may be mentioned, in which the nickel layer forms the exterior of the housing. Cell cups and/or cell covers composed of trimetal are also particularly suitable. Cell housings composed of sheet steel with an external layer composed of nickel and an internal layer composed of copper are particularly protected against the electrochemical loads which occur in an electrochemical element, and at the same time ensure good contact of the coating provided on the exterior.

The seal for the button cell may be a sheet seal. Suitable sheet seals are described, for example, in DE 196 47 593.

It is, of course, also possible for the seal of a button cell to be an injection-molded seal. Injection-molded seals for button cells have already been known for many years and do not require any more detailed explanation.

It is also possible for the seal to be a thin polymer film, which has been formed by application and subsequent curing of a polymer precursor. The term polymer precursor in this case means all single-component and multiple-component systems from which compounds with a polymer structure can be produced. The at least one polymer precursor may have both reactive individual monomers and pre-crosslinked monomer components. The at least one polymer precursor s preferably in liquid form, for example, as a lacquer, to which at least one housing part is applied, and depositions from the gas phase are, however, also possible. The at least one polymer precursor is particularly preferably a parylene precursor or an ormocer precursor. Suitable ormocer precursors are described, for example, in DE 100 16 324.

The button cell generally has an anode, a cathode, a separator and an electrolyte.

In principle, the button cell may contain electrochemical systems of widely different types. Some of these have already been mentioned initially. If the button cell is a primary battery, it particularly preferably has the electrochemical system zinc/MnO₂.

If the button cell is a secondary battery, then nickel/metal-hydride systems or else systems with a lithium-intercalating electrode are particularly preferable.

The button cell is particularly preferably a button cell for hearing aids, in particular, a rechargeable button cell for hearing aids.

Cell cups and cell covers of a button cell preferably have a wall thickness of between 0.08 mm and 0.2 mm, in particular, of between 0.1 mm and 0.15 mm (without coating).

An alkaline electrolyte is used, in particular, as the electrolyte in a button cell. Suitable electrolytes are known.

The coating of the exterior of the housing resulted in the button cell having extremely high stability with respect to corrosive attacks. In particular, even in hearing aids, button cells can be used over long time periods without the initially mentioned rust blooming occurring.

This disclosure likewise relates to the use of the materials mentioned above, which are suitable for coating substrates such as button cell housings, as a corrosion protection means for button cells, in particular, as a corrosion-inhibiting layer or to produce a corrosion-inhibiting coating such as this on the exterior of a button cell.

Inter alia, and as already mentioned above, non-conductive coating materials are particularly preferred for this purpose, in particular, materials such as valve metals (which can be oxidized after coating), ormocers and/or parylenes.

Reference is hereby made to the above statements relating to electrically conductive and non-conductive materials.

Furthermore, this disclosure also relates to a method for production of a corrosion-protected button cell, in particular, of a button cell. On the basis of the method, an electrically conductive coating and/or an electrically non-conductive coating are/is applied to the exterior of the button cell housing of a button cell, in particular, to the cell cup and/or to the cell cover, before or after their assembly. The application is preferably carried out in the casing area of the cell cup, that is to say in the area which also forms the casing of the assembled button cell. Reference is hereby made to the above statements relating to electrically conductive and non-conductive materials, relating to the button cells and button cell housings which can be coated with these materials, and relating to the preferred areas of the button cell housing in which a coating is applied.

In the method, at least one electrically non-conductive coating material from the group comprising valve metals, ormocers and/or parylenes is preferably applied.

A valve metal oxide is particularly preferably applied to the exterior of the button cell housing. In this case, at least one valve metal, in particular, from the group comprising aluminum, tantalum, niobium, manganese, titanium, bismuth, antimony, zinc, cadmium, zirconium, tungsten, tin, iron, silver and silicon, is preferably applied in a first step. In a second step, the valve metal which has been applied to the exterior of the button cell housing is then oxidized, in particular, by anodic oxidation. The color of the valve metal oxide coating can also particularly advantageously be adjusted by the voltage during the anodic oxidation. The valve metal oxide layer is very hard and is electrically non-conductive. This has the additional advantage that this also results in an improvement in the scratch resistance and corrosion protection.

The at least one valve metal is preferably applied using a PVD method, in particular, by magnetron sputtering.

FIG. 1 shows one example of a button cell i whose exterior has an electrically non-conductive coating 2 (with the coating 2 being illustrated only as shading). The button cell 1 is illustrated partially in the form of a cross-section. The housing of the button cell is essentially cylindrical. The cell cup 3 and cell cover 4 of the button cell have an essentially flat bottom area (see the cup bottom 5 and the cover bottom 6). The electrical contact units of a load are preferably fitted in these areas. The housing has a casing-like section, as has already been mentioned in the general part of the description. The casing-like section is formed by the outer wall of the cell cup 3. This is essentially completely covered by the electrically non-conductive coating 2. The transition from the casing-like section to the cup bottom 5 is in the form of a slightly rounded edge 7. The casing-like section extends upward to the point beyond which the rim 8 of the cell cup 3 is curved inward to ensure that it rests closely on the cell cover 4. The flanged zone of the button cell is located here. A seal 9 separates the cell cup 3 from the cell cover 4. Furthermore, the illustration shows the anode 10, the cathode 11 and the separator 12. An annular supporting element is annotated 13.

The area of the exterior which is provided with the coating 2 is illustrated merely in a shaded form in FIG. 1. The coating 2 essentially completely covers the housing casing while, in contrast, the cup bottom 5 and the cover bottom 6 are not coated. The flanged zone is likewise covered by the coating 2. In this area, the coating covers both the bent rim 8 of the cell cup 3 and the gap between the cell cup 3 and the cell cover 4, and therefore also the seal 9.

### EXAMPLE

(1) A polymer dissolved in toluene (a polyurethane elastomer) was applied to the housing (composed of nickel-plated deep-drawn sheet metal) of a cylindrical button cell of size PR 44 (675). The polymer solution was applied to the housing casing, with the area of the peening also being included. The upper face and the lower face of the button cell (the cup bottom and the cover bottom) were not coated. The solvent was then removed, and the polymer was cured. A colorless, electrically non-conductive clear lacquer layer was obtained, with a thickness of 50 μm. The resultant button cell is shown in FIG. 1.

In practical tests, button cells coated in this way were found to be considerably more corrosion-resistant than comparable button cells without a coating.

(2) A plasma composed of titanium and nitrogen ions was produced using an arc process at several hundred degrees Celsius in a hard-vacuum chamber. An electrically conductive coating with a thickness of about 2 μm and composed of titanium nitride was produced by the plasma on the exterior of a cell cover and of a cell cup composed of nickel-plated deep-drawn sheet metal (intended for button cells of the size PR 44). The coated parts were then assembled to form a button cell, in the normal manner.

In practical tests, button cells coated in this way were found to be considerably more corrosion-resistant than comparable button cells without a coating. It was not possible to find any contact problems resulting from the coating with titanium nitride.

(3) A niobium coating was sputtered onto the exterior of a cell cup composed of nickel-plated deep-drawn sheet metal (intended for button cells of the size PR 44). The sputtering process was carried out only in the casing area of the cell cup, and its bottom remained free.

The niobium coating was then anodically oxidized, resulting in a green layer of Nb₂O₅ with a thickness of between 200 nm and 300 nm. The cell cup provided with the layer of Nb₂O₅ was found in practical tests to be considerably more corrosion-resistant than comparable uncoated cell cups.

1-19. (canceled)

20. A button cell comprising:
a housing comprising a cell cup and having an. exterior electrically non-conductive coating, a cell cover and a seal which isolates the. cell cup and the cell cover from one another.

21. The button cell as claimed in claim 20, wherein the electrically non-conductive coating comprises at least one organic-component.

22. The button cell as claimed, in claim 20, wherein the electrically non-conductive coating comprises at least one organic component on a polymer basis.

23. The button cell as claimed in claim 20, wherein the electrically non-conductive coating comprises an organic/inorganic hybrid component based on an ormocer.

24. The button cell as claimed in claim 20, wherein the electrically non-conductive coating comprises parylene.

25. The button cell as claimed in claim 20, wherein an exterior of the housing has one or more uncoated subareas essentially free of the electrically non-conductive coating.

26. The button cell as claimed in claim 20, wherein the button cell has a easing housing section which is provided at least in places with the electrically non-conductive coating.

27. The button cell as claimed in claim 20, wherein the button cell has a flanged area covered by the electrically non-conductive coating.

28. The button cell as claimed in claim 20, wherein the electrically non-conductive coating has a thickness of between 1 μm and 200 μm.

29. The button cell as claimed in claim 20, wherein the -electrically non-conductive coating has at least one dye and/or at least one pigment.

30. The button cell as claimed in claim 20, wherein the button cell is a rechargeable button cell.

31. The button cell as claimed in claim 20, wherein the button cell is a nickel metal-hydride button cell.

32. The button cell as claimed in claim 20. wherein the button cell is a button cell with a lifetime-intercalating electrode.

33. A method for producing a corrosion-protected button cell comprising applying at least one electrically non-conductive coating material to at least a portion of an exterior portion of a button cell housing.

34. The method according to claim 33, wherein the at least one electrically non-conductive coating material is at least one selected from the group consisting of valve metal oxides, organic/inorganic hybrid polymers and parylenes.

35. The method as claimed in claim 33, wherein the at least one valve metal is applied and then oxidized.

36. The method as claimed in claim 35, wherein the at least one valve metal is applied by a PVD method.

37. The method as claimed in claim 35, wherein the valve metal oxide is produced by anodic oxidation.
